(19) United States
(12) Patent Application Publication
(10) Pub. No.: US 2026/0134479 A1
(43) Pub. Date: May 14, 2026

(54) AUTONOMOUS CAPITAL ALLOCATION GOVERNANCE SYSTEM

(71) Applicant: George William Bickerstaff, III, Greenwich, CT (US)

(72) Inventor: George William Bickerstaff, III, Greenwich, CT (US)

(21) Appl. No.: 19/444,250

(22) Filed: Jan. 9, 2026

(51) Int. Cl. G06Q 40/06

(52) U.S. Cl. CPC G06Q 40/067

(57) ABSTRACT

An autonomous capital allocation governance system is disclosed that enforces machine-executable governance constraints on allocation decisions at execution time. The system intercepts, modifies, blocks, or escalates allocation requests prior to completion and generates cryptographically verifiable audit artifacts, enabling scalable autonomous allocation with deterministic oversight.

### TECHNICAL FIELD

The present invention relates to autonomous decision systems and, more particularly, to technical systems and methods for governing execution-time capital allocation decisions through machine-enforced constraints, runtime interception, and auditable control mechanisms.

### BACKGROUND

Autonomous and semi-autonomous systems are increasingly used to allocate capital, resources, or value across portfolios, projects, counterparties, or infrastructure components. These systems may rely on algorithmic decision engines, optimization routines, or artificial intelligence to determine allocation outcomes in real time. While such systems improve efficiency and scalability, they also introduce risks associated with uncontrolled execution, concentration, feedback loops, and systemic exposure.

Existing capital governance mechanisms rely primarily on static limits, batch approvals, or post-execution audits. Such approaches are insufficient in environments where allocation decisions are executed continuously and autonomously. Once an allocation is executed, reversal may be infeasible, and risk may propagate rapidly across interconnected systems.

Accordingly, there exists a need for a technical system that enforces governance constraints at execution time, intercepts non-compliant allocation decisions before completion, supports modification or escalation, and produces machine-verifiable audit artifacts reflecting autonomous capital allocation behavior.

### SUMMARY OF THE INVENTION

The invention provides an autonomous capital allocation governance system configured to enforce machine-executable governance constraints on capital allocation decisions prior to execution. The system evaluates allocation requests against dynamically updated rule sets, intercepts execution when constraints are violated, modifies or blocks allocation decisions, and records cryptographically verifiable audit artifacts.

By embedding governance enforcement directly into the execution pathway, the system prevents uncontrolled capital propagation, reduces systemic risk amplification, and enables scalable autonomous allocation with deterministic oversight.

### DEFINITIONS

### Allocation Audit Artifact

A cryptographically verifiable data structure recording an allocation request, applied governance rules, execution outcome, and system state.

### Allocation Request

A machine-readable instruction requesting allocation of capital or value.

### Execution Interception Layer

A system component configured to intercept allocation execution prior to completion.

### Governance Rule Set

A machine-executable collection of constraints governing allocation behavior.

### Human Oversight Interface

A system interface enabling review of intercepted or escalated allocation decisions.

### Machine-executable Constraint

A rule represented in a form directly evaluable by a computing system without manual interpretation.

### Runtime Allocation Gate

A control point at which allocation requests are evaluated before execution.

### Systemic Exposure Metric

A computed measure of aggregate allocation concentration or risk.

### Violation Signal

A machine-generated indicator that an allocation violates one or more governance constraints.

### Value Allocation Engine

A computational component configured to determine allocation outcomes.

### BRIEF DESCRIPTION OF THE DRAWINGS

FIG. 1 illustrates allocation request intake and preprocessing.

FIG. 2 illustrates governance rule evaluation and constraint enforcement.

FIG. 3 illustrates execution-time interception and modification.

FIG. 4 illustrates escalation and recovery workflows.

FIG. 5 illustrates audit artifact generation and replay.

### DETAILED DESCRIPTION OF THE INVENTION

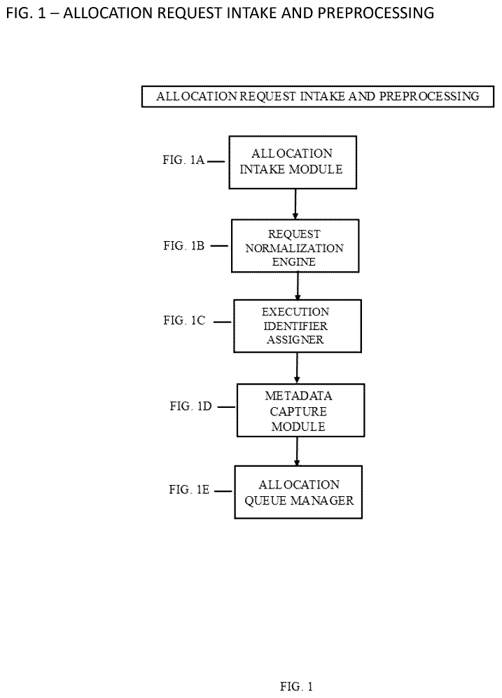

### FIG. 1—Allocation Request Intake and Preprocessing

FIG. 1 illustrates the intake and preprocessing of capital allocation requests prior to execution. Allocation requests are normalized, identified, and prepared for governance evaluation. This figure establishes the entry point for execution-time governance enforcement.

### FIG. 1A—Allocation Intake Module

FIG. 1A depicts a module configured to receive allocation requests from autonomous or semi-autonomous systems. The module validates request structure and extracts relevant allocation parameters. Received requests are forwarded for normalization and tracking.

### FIG. 1B—Request Normalization Engine

FIG. 1B illustrates a normalization engine that converts allocation requests into a machine-readable canonical format. Normalization ensures consistent downstream rule evaluation. The engine removes ambiguity in request representation.

### FIG. 1C—Execution Identifier Assigner

FIG. 1C shows a component that assigns a unique execution identifier to each allocation request. The identifier enables traceability across evaluation, interception, and audit stages. Identifiers are preserved throughout the allocation lifecycle.

### FIG. 1D—Metadata Capture Module

FIG. 1D depicts a module that captures contextual metadata associated with allocation requests. Metadata may include timing, source system state, and dependency context. Captured metadata supports audit and replay functionality.

### FIG. 1E—Allocation Queue Manager

FIG. 1E illustrates a queue manager that orders allocation requests for governance evaluation. The queue manager controls evaluation sequencing and throughput. Requests remain queued until governance checks are completed.

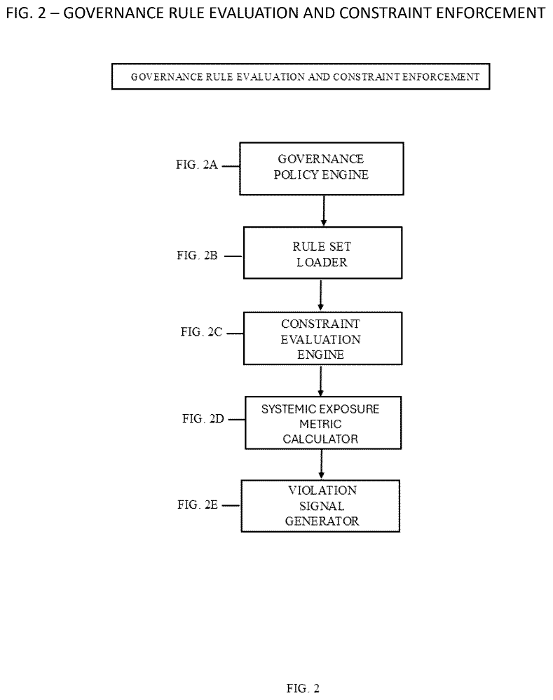

### FIG. 2—Governance Rule Evaluation and Constraint Enforcement

FIG. 2 illustrates evaluation of allocation requests against governance constraints prior to execution. Machine-executable rules are applied deterministically. Violations are detected before capital movement occurs.

### FIG. 2A—Governance Policy Engine

FIG. 2A depicts a governance policy engine configured to coordinate rule evaluation. The engine retrieves applicable governance rules and applies them to allocation requests. Evaluation results are generated in real time.

### FIG. 2B—Rule Set Loader

FIG. 2B illustrates a component that loads governance rule sets represented as machine-executable constraints. Rule sets may be updated dynamically without interrupting execution. Loaded rules define permissible allocation behavior.

### FIG. 2C—Constraint Evaluation Engine

FIG. 2C shows an engine that evaluates allocation requests against governance constraints. Constraints may include limits, diversification rules, or systemic exposure thresholds. Evaluation outcomes determine whether execution may proceed.

### FIG. 2D—Systemic Exposure Metric Calculator

FIG. 2D illustrates a module that computes aggregate exposure and concentration metrics. Metrics reflect current system-wide allocation state. Computed values are used during constraint evaluation.

### FIG. 2E—Violation Signal Generator

FIG. 2E depicts a generator that produces violation signals when constraints are breached. Violation signals indicate non-compliant execution states. Generated signals trigger execution interception.

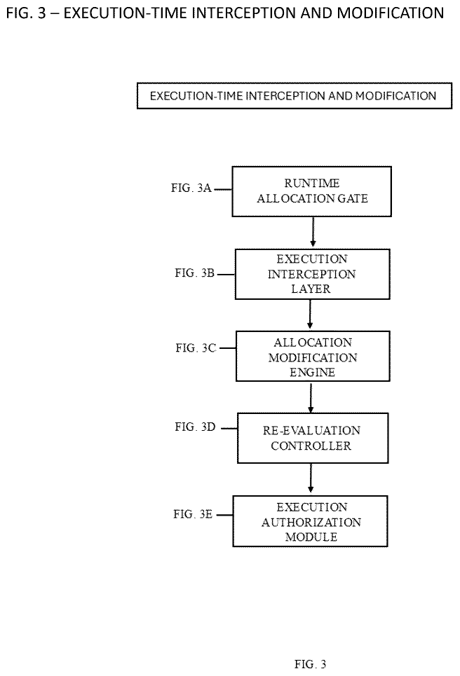

### FIG. 3—Execution-Time Interception And Modification

FIG. 3 illustrates interception and modification of allocation requests prior to execution. Execution control occurs in real time. This figure represents the core enforcement mechanism of the system.

### FIG. 3A—Runtime Allocation Gate

FIG. 3A shows a gate through which allocation requests must pass before execution. The gate evaluates governance outcomes and violation signals. Execution is permitted only when constraints are satisfied.

### FIG. 3B—Execution Interception Layer

FIG. 3B illustrates a layer configured to intercept allocation execution prior to completion. Interception prevents irreversible capital movement. Intercepted requests are routed for modification or escalation.

### FIG. 3C—Allocation Modification Engine

FIG. 3C depicts an engine that modifies allocation parameters to satisfy governance constraints. Modifications may include amount reduction or redistribution. Modified requests are re-evaluated before execution.

FIG. 3D—Re-Evaluation Controller

FIG. 3D illustrates a controller that re-evaluates modified allocation requests. The controller ensures modifications comply with governance rules. Re-evaluation prevents repeated violations.

### FIG. 3E—Execution Authorization Module

FIG. 3E shows a module that authorizes execution of compliant allocation requests. Authorization occurs only after successful evaluation. Authorized requests proceed to execution.

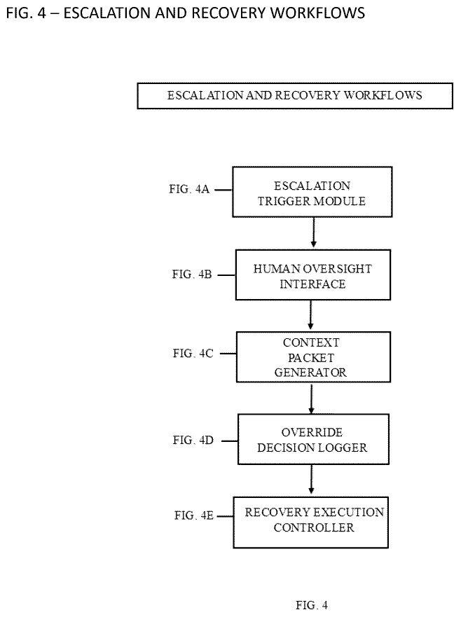

### FIG. 4—Escalation And Recovery Workflows

FIG. 4 illustrates escalation and recovery when allocation requests cannot be automatically resolved. Human oversight is integrated into the execution pathway. All decisions are auditable.

### FIG. 4A—Escalation Trigger Module

FIG. 4A depicts a module that determines when escalation is required. Escalation occurs when automatic modification cannot satisfy constraints. The module initiates human review workflows.

### FIG. 4B—Human Oversight Interface

FIG. 4B illustrates an interface enabling human review of escalated allocations. Reviewers may approve, reject, or modify requests. Oversight decisions are recorded.

### FIG. 4C—Context Packet Generator

FIG. 4C shows a generator that assembles contextual information for escalation. Context includes rule evaluations, metrics, and system state. Generated packets support informed decision-making.

### FIG. 4D—Override Decision Logger

FIG. 4D illustrates a logger that records override or rejection decisions. Logged decisions include rationale and system state. Records support audit and compliance review.

### FIG. 4E—Recovery Execution Controller

FIG. 4E depicts a controller that executes approved recovery actions. Recovery may involve re-execution or cancellation. All recovery actions are tracked.

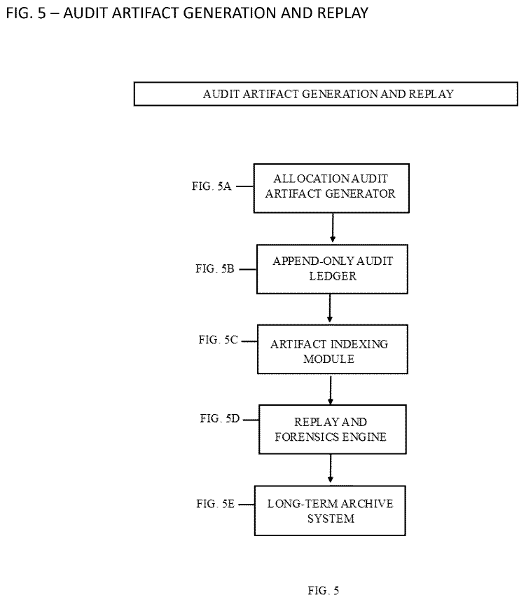

### FIG. 5—Audit Artifact Generation And Replay

FIG. 5 illustrates generation and management of audit artifacts for allocation decisions. Artifacts provide deterministic replay capability. This figure supports transparency and accountability.

### FIG. 5A—Allocation Audit Artifact Generator

FIG. 5A depicts a generator that produces cryptographically verifiable audit artifacts. Artifacts capture allocation requests, rule evaluations, and outcomes. Generated artifacts represent authoritative execution records.

### FIG. 5B—Append-Only Audit Ledger

FIG. 5B illustrates an append-only ledger storing audit artifacts. The ledger prevents retroactive modification. Stored artifacts preserve historical integrity.

### FIG. 5C—Artifact Indexing Module

FIG. 5C shows a module that indexes audit artifacts for retrieval. Indexing supports efficient lookup and analysis. Artifacts remain immutable after indexing.

### FIG. 5D—Replay And Forensics Engine

FIG. 5D illustrates an engine that replays allocation decisions using stored artifacts. Replay reconstructs system state at execution time. Forensic analysis is supported without re-execution.

### FIG. 5E—Long-Term Archive System

FIG. 5E depicts a system for long-term storage of audit artifacts. Archives support retention and compliance requirements. Stored data remains accessible for future review.

### ILLUSTRATIVE OPERATIONAL EXAMPLE (NON-LIMITING)

In one illustrative, non-limiting example, an autonomous capital allocation system receives allocation requests for distributing capital across multiple investment targets. Each allocation request is ingested by an allocation intake module and assigned a unique execution identifier.

A governance policy engine retrieves a governance rule set defining concentration thresholds, diversification constraints, and aggregate exposure limits. Prior to execution, the allocation request is evaluated by a runtime allocation gate against current systemic exposure metrics.

In one instance, the runtime allocation gate detects that executing the requested allocation would exceed a predefined concentration threshold. The execution interception layer intercepts the allocation before completion and generates a violation signal. The system modifies the allocation amount and re-evaluates the modified allocation against the governance rule set.

Following successful re-evaluation, the modified allocation is executed. An allocation audit artifact is generated recording the original request, detected violation, applied modification, and execution outcome. The artifact is stored in an append-only audit ledger.

In another instance, an allocation request cannot be modified to satisfy governance constraints. The allocation is blocked and escalated to a human oversight interface. The escalation decision and system state are preserved as an audit artifact.

1. An autonomous capital allocation governance system, comprising:
a value allocation engine configured to generate allocation requests;
a governance policy engine configured to evaluate the allocation requests using a governance rule set comprising machine-executable constraints; and
an execution interception layer configured to intercept allocation execution prior to completion when a violation signal is generated.

2. A method for governing autonomous capital allocation, comprising:
receiving an allocation request;
evaluating the allocation request against a governance rule set at runtime;
intercepting execution of the allocation request when a constraint is violated; and
modifying, blocking, or escalating the allocation request.

3. A non-transitory computer-readable medium storing instructions that, when executed, cause a system to govern autonomous capital allocation using execution-time interception and audit artifact generation.

4. The system of claim 1, wherein the governance rule set includes concentration thresholds.

5. The system of claim 1, wherein intercepted allocations are modified and re-evaluated prior to execution.

6. The method of claim 2, further comprising generating an allocation audit artifact.

7. The method of claim 2, wherein blocked allocations are escalated to a human oversight interface.

8. The system of claim 1, wherein audit artifacts are stored in an append-only ledger.

9. The computer-readable medium of claim 3, wherein allocation behavior is replayable from stored artifacts.

10. The system of claim 1, wherein governance enforcement occurs continuously during runtime operation.
